(19) United States
(12) Patent Application Publication
(10) Pub. No.: US 2006/0259757 A1
(43) Pub. Date: Nov. 16, 2006

(54) Method, apparatus and computer program product for implementing initial program load in a computer system

(75) Inventors: Sheldon Ray Bailey, Rochester, MN (US); Daniel Morgan Crowell, Rochester, MN (US); Philip James Sanders, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/128,058

(22) Filed: May 12, 2005

(51) Int. Cl. G06F 1/24

(52) U.S. Cl. 713/100

(57) ABSTRACT

A method, apparatus and computer program product are provided for implementing initial program load to configure system hardware in a computer system. During an initial program load of the computer system, selected hardware components are marked with a temporary state of non-functional. At least one policy check is performed based upon a system type for the computer system to determine system availability. When system availability is identified, then the selected hardware components are permanently deconfigured and the initial program load of the computer system is continued.

### FIELD OF THE INVENTION

The present invention relates generally to the data processing field, and more particularly, relates to a method, apparatus and computer program product for implementing initial program load to configure system hardware in a computer system including speculative deconfiguration of system hardware.

### DESCRIPTION OF THE RELATED ART

Reliability, availability, and serviceablility (RAS) features provided in some data processing systems enable enhanced error detection and prevention capabilities.

For example, the RS/6000® server computer system manufactured and sold by International Business Machines Corporation of Armonk, N.Y., includes a unique RAS feature called Repeat-Gard.

The Repeat-Gard feature provides the capability to deconfigure portions of hardware that are determined to be defective either via diagnostics run during initial program load (“IPL”) or during runtime. A user also has the capability of indicating hardware is defective by manual intervention. Deconfiguring portions of hardware may cause other working pieces of a system to be deconfigured as well because they cannot be used without the original part.

There are cases where so much hardware has been deconfigured that a system will not IPL. Typically, this does not occur due to the faulty part alone, but as a result of the deconfiguration of associated parts. This deconfiguration by association concept is a cascade of dependencies unknown to the software that is performing the initial deconfiguration. Conventionally, all dependencies must be known by multiple software applications and all deconfiguration actions are necessarily permanent.

A need exists for a method and mechanism for implementing initial program load including speculative deconfiguration of system hardware in a computer system.

### SUMMARY OF THE INVENTION

Principal aspects of the present invention are to provide a method, apparatus and computer program product for implementing initial program load to configure system hardware in a computer system. Other important aspects of the present invention are to provide such method, apparatus and computer program product for implementing initial program load of system hardware in a computer system substantially without negative effect and that overcome many of the disadvantages of prior art arrangements.

In brief, a method, apparatus and computer program product are provided for implementing initial program load to configure system hardware in a computer system. During the initial program load of the computer system, selected hardware components are marked with a temporary state of non-functional. At least one policy check is performed based upon a system type for the computer system to determine system availability. When system availability is identified, the selected hardware components are permanently deconfigured and the initial program load of the computer system is continued.

In accordance with features of the invention, when determined that the system availability fails, the selected hardware components are reconfigured and the initial program load of the computer system is continued. System availability is identified when the computer system has enough functioning hardware to run. For example, a processor, memory, a path to the memory, an input/output (I/O) bridge, and an I/O adapter may be required for system availability; while the required hardware is system specific.

In accordance with features of the invention, a hardware manager in the computer system marks the selected hardware components with the temporary state of non-functional. A client IPL deconfiguration control program requests the hardware manager to mark the selected hardware components with the temporary state of non-functional based upon a failure or an action from a prior initial program load. When a selected hardware component is marked with the temporary state of non-functional, hardware components associated with the selected hardware component are marked with the temporary state of non-functional.

In accordance with features of the invention, the hardware manager performs the policy check based upon the system type for the computer system to determine system availability, responsive to marking the selected hardware components with the temporary state of non-functional. The client IPL deconfiguration control program forces the selected hardware components to permanently deconfigured when the hardware manager determines system availability. Otherwise, when the hardware manager determines that the system is unavailable to complete the initial program load of the computer system, the client IPL deconfiguration control program forces the selected hardware components to functional.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1 and 2 is a schematic diagram of an exemplary computer system and operating system for implementing methods for initial program load including speculative deconfiguration of system hardware in accordance with the preferred embodiment;

FIG. 3 is a flow chart illustrating exemplary steps of methods for implementing initial program load including speculative deconfiguration of system hardware in accordance with the preferred embodiment;

FIG. 4 is a block diagram illustrating a computer program product in accordance with the preferred embodiment.

### DETAILED DESCRIPTION OF THE PREFERRED EMBODIMENTS

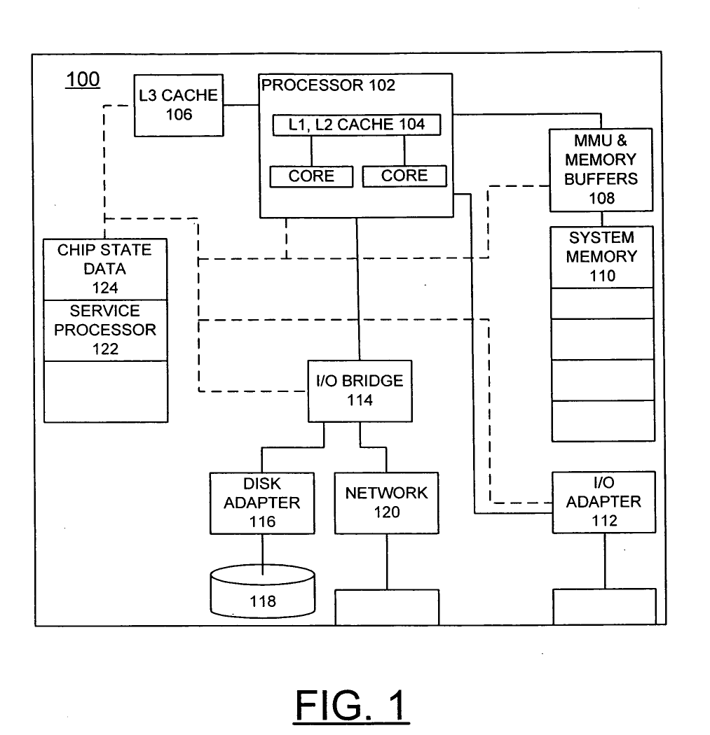

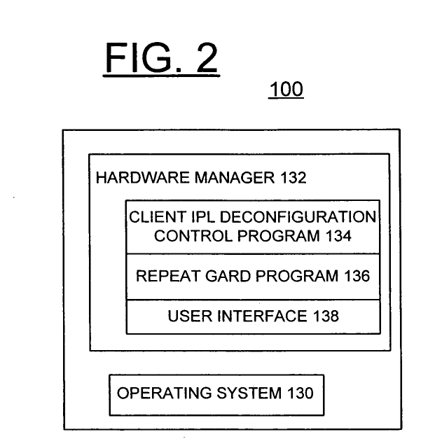

Referring now to the drawings, in FIGS. 1 and 2 there is shown an exemplary computer system generally designated by the reference character 100 for implementing methods for initial program load including speculative deconfiguration of system hardware in accordance with the preferred embodiment. Computer system 100 includes a main processor 102 and associated L1, L2 cache 104 and L3 cache 106. Main processor 102 is coupled to a memory management unit (MMU) and memory buffers 108 and system memory 110, such as a dynamic random access memory (DRAM) 110. Main processor 102 is coupled to an input/output (I/O) 112 and an input/output (I/O) bridge interface 114, coupled to a disk adapter 116 connected to a direct access storage device (DASD) 118, and coupled to a network adapter 120. Computer system 100 includes a service processor 122 including associated chip state data 124. As indicated by dotted line, the service processor 122 is coupled to the L3 cache 106, main processor 102, MMU and memory buffers 108, 1/O adapter 112, and I/O bridge 114.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, instead of a single main processor 102, multiple main processors can be used.

As shown in FIG. 2, computer system 100 includes an operating system 130, a hardware manager 132, a client IPL deconfiguration control program 134 of the preferred embodiment, a hardware manager (such as the Repeat-Gard program) 136, and a user interface 138. Chip state data 124 are stored in accordance with the IPL deconfiguration control methods of the preferred embodiment.

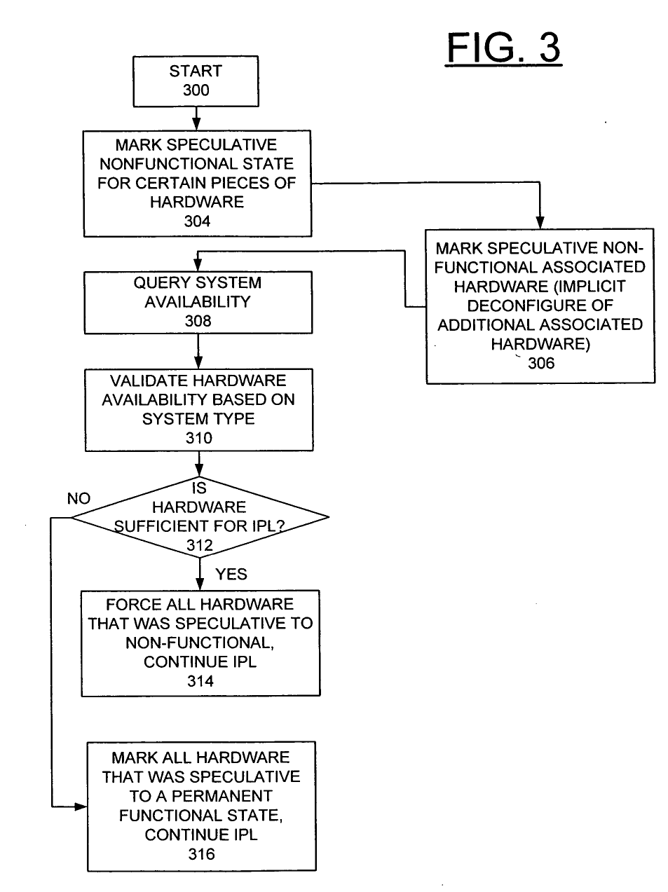

Various commercially available computers can be used for computer system 100, for example, an IBM personal computer or an IBM server computer. CPU 102 is suitably programmed by the client IPL deconfiguration control program 134 to execute the flowchart of FIG. 3 for implementing IPL in accordance with the preferred embodiment.

In accordance with features of the preferred embodiment, methods are provided that allow software run during an IPL to determine if deconfiguring a piece of hardware will cause the system to fail during the IPL and to bring back enough hardware to allow the IPL. This enables a customer, in emergency situations, to continue to use the computer system 100 until a service call can be made and completed. In conventional arrangements, the system would not be able to complete IPL until a service action was completed or the user manually reconfigured hardware.

In accordance with features of the preferred embodiment, methods implement speculative deconfiguration of system hardware, providing the capability for computer system 100 to allow a user to temporarily set the state of hardware to non-functional as well as any of its associated hardware. If it is determined that there is enough good hardware to IPL the system 100, the state of the marked hardware can change to a more permanent non-functional state or have the functional state restored as required.

In a computer system, it is not enough just to reconfigure or un-guard a piece of hardware and expect the associated hardware to be reconfigured automatically because more than one piece of hardware affects another piece of hardware within in the system.

In accordance with features of the preferred embodiment, methods allow the hardware manager 132 performing a Repeat-Gard function to first check if deconfiguring a hardware component may cause the system 100 to not IPL. If the Repeat-Gard program determines that this is the case and that the original failure was not a fatal problem, then the hardware component is reconfigured and marked as functional and the system 100 continues to IPL. If deconfiguring the hardware would not cause an IPL failure, the hardware manager 132 performs a Repeat-Gard function to permanently deconfigure the hardware component, while allowing the system to continue IPL. Additional details about the Repeat-Gard program can be found in the technical white paper entitled The RS/6000 Enterprise Server S Family: Reliability, Availability, Serviceability and the IBM redbook entitled IBM eServer PSeries 680 Handbook: Including the RS/6000 Model S80, which are herein incorporated by reference in their entirety.

Referring now to FIG. 3, there are shown exemplary steps of methods for implementing initial program load in accordance with the preferred embodiment starting at a block 300. A temporary state of an identified hardware component or certain pieces of hardware are marked speculatively non-functional based upon a failure or actions done on a prior IPL as indicated in a block 304.

For example, the client IPL deconfiguration control program 134 requests the hardware manager 132 to mark a certain hardware component or certain pieces of hardware as speculatively non-functional at block 304. As the state of hardware is marked non-functional, the associated hardware is also marked speculative non-functional as indicated in a block 306.

Next system availability is queried as indicated in a block 308, where the client IPL deconfiguration control program 134 asks the hardware manager 132 if there is enough hardware available to IPL the computer system 100. Hardware availability is validated based upon system type as indicated in a block 310. For example, the hardware manager 132 runs a number of policy checks based on the system type to validate hardware availability.

Then it is determined whether the hardware is sufficient to complete IPL of the computer system 100 as indicated in a decision block 312. If the hardware manager 132 indicates that there is enough hardware to IPL, the client IPL deconfiguration control program 134 will change all the speculatively deconfigured pieces of hardware to permanently deconfigured and continue the IPL as indicated in a block 314.

If the hardware manager 132 indicates that there is not enough hardware to run, the client IPL deconfiguration control program 134 will force all the speculatively deconfigured pieces functional again and continue the IPL as indicated in a block 316.

Each piece of hardware that was marked speculatively deconfigured, both directly and by association, is marked with the requested new state at blocks 314, 316.

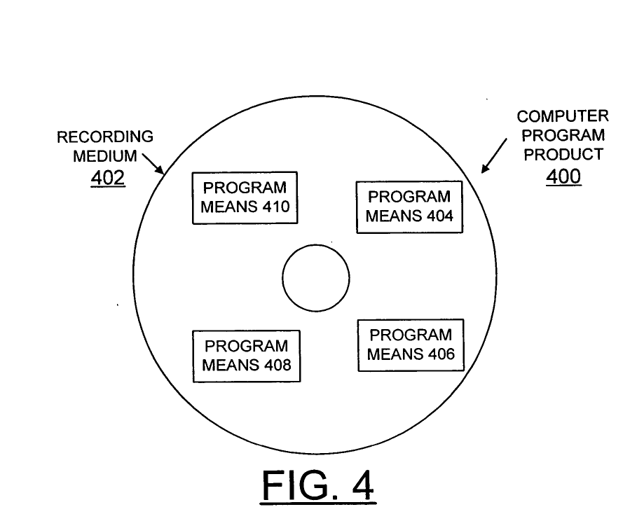

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing methods for initial program load including speculative deconfiguration of the preferred embodiment in the system 100 of FIGS. 1 and 2.

A sequence of program instructions or a logical assembly of one or more interrelated modules defined by the recorded program means 404, 406, 408, 410, direct the computer system 100 for implementing initial program load with speculative deconfiguration of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing initial program load to configure system hardware in a computer system comprising:
marking selected hardware components speculatively non-functional;
performing at least one policy check to determine system availability;
permanently deconfiguring the selected hardware components responsive to system availability being determined; and
continuing the initial program load of the computer system.

2. A method for implementing initial program load as recited in claim 1 further comprising responsive to determining failed system availability, reconfiguring the selected hardware components by marking the selected hardware components with a state of functional; and continuing the initial program load of the computer system.

3. A method for implementing initial program load as recited in claim 1 wherein marking selected hardware components speculatively non-functional comprises marking an identified hardware component with a temporary state of non-functional and marking each associated hardware component for said identified hardware component with a temporary state of non-functional.

4. A method for implementing initial program load as recited in claim 3 wherein the computer system includes a hardware manager and wherein said hardware manager marks the selected hardware components with the temporary state of non-functional.

5. A method for implementing initial program load as recited in claim 4 wherein the computer system includes a client IPL deconfiguration control program and wherein marking selected hardware components with a temporary state of non-functional includes said client IPL deconfiguration control program requesting said hardware manager to mark the selected hardware components with the temporary state of non-functional, said request based upon a failure or an action from a prior initial program load.

6. A method for implementing initial program load as recited in claim 1 wherein the policy check is based at least in part upon a system type for the computer system

7. A method for implementing initial program load as recited in claim 6 wherein the computer system includes a hardware manager and wherein said hardware manager performs the policy check based at least in part upon the system type for the computer system to determine system availability, responsive to marking the selected hardware components with the temporary state of non-functional.

8. A method for implementing initial program load as recited in claim 7 wherein the computer system includes a client IPL deconfiguration control program and wherein said client IPL deconfiguration control program forces the selected hardware components to permanently deconfigured when said hardware manager determines system availability.

9. A method for implementing initial program load as recited in claim 8 wherein responsive to said hardware manager determining system unavailability to complete the initial program load, said client IPL deconfiguration control program forces the selected hardware components to functional.

10. A method for deploying computing infrastructure, comprising integrating computer readable code into a computing system, wherein the code in combination with the computing system is capable of performing the method of claim 1.

11. Apparatus for implementing initial program load to configure system hardware in a computer system comprising:
a hardware manager for configuring hardware components in the computer system;
a client IPL deconfiguration control program for requesting said hardware manager to mark the selected hardware components with the temporary state of non-functional, said request based upon a failure or an action from a prior initial program load;
said hardware manager marking the selected hardware components with the temporary state of non-functional and performing a policy check based upon the system type for the computer system to determine system availability, and
said client IPL deconfiguration control program forces the selected hardware components to permanently deconfigured when said hardware manager determines system availability, and continues the initial program load of the computer system.

12. Apparatus for implementing initial program load as recited in claim 11 said client IPL deconfiguration control program forces the selected hardware components to functional responsive to said hardware manager determining system unavailability to complete the initial program load, and continues the initial program load of the computer system.

13. A computer program product for implementing initial program load to configure system hardware in a computer system, said computer program product including instructions executed by the computer system to cause the computer system to perform:
marking selected hardware components with a temporary state of non-functional;
performing at least one policy check based upon a system type for the computer system to determine system availability;
permanently deconfiguring the selected hardware components responsive to system availability being determined, and continuing the initial program load of the computer system.

14. A computer program product for implementing initial program load as recited in claim 13 further comprising responsive to determining failed system availability, reconfiguring the selected hardware components by marking the selected hardware components with a state of functional; and continuing the initial program load of the computer system.

15. A computer program product for implementing initial program load as recited in claim 13 wherein marking selected hardware components with a temporary state of non-functional includes marking an identified hardware component with a temporary state of non-functional and marking each associated hardware component for said identified hardware component with a temporary state of non-functional.
